(19) United States
(12) Patent Application Publication
(10) Pub. No.: US 2024/0158112 A1
(43) Pub. Date: May 16, 2024

(54) Foldable Drone Landing Pad

(71) Applicant: Olivier LE LANN, Berlin, DE (US)

(72) Inventor: Olivier LE LANN, Berlin, DE (US)

(21) Appl. No.: 18/056,121

(22) Filed: Nov. 16, 2022

(51) Int. Cl. B64U 70/92; B64U 70/95; H01M 10/42; H01M 50/247; H01M 50/256; H01M 50/262

(52) U.S. Cl. CPC B64U 70/92; B64U 70/95; H01M 10/425; H01M 50/247; H01M 50/256; H01M 50/262; H01M 2220/30

(57) ABSTRACT

A foldable drone landing pad includes a first landing platform, a second landing platform, at least one hinge mechanism, a chipset, a rechargeable battery, and a plurality of drone tracking features. The first landing platform and the second landing platform each includes a frame and a plurality of panels that fully enclose the frame. The first landing platform and the second landing platform are foldably mounted to each other by the hinge mechanism. The chipset and the rechargeable battery are internally mounted to the first landing platform. The plurality of drone tracking features is integrated to the first landing platform and the second landing platform and include a GPS, a lighting system, proximity sensors, an infrared beacon, and wireless communication modules. The chipset and the plurality of drone tracking features are electrically connected to the rechargeable battery. The plurality of drone tracking features is electronically connected to the chipset.

### FIELD OF THE INVENTION

The present invention relates generally to an unmanned aerial vehicle (UAV), commonly known as a drone. More specifically, the present invention is a portable and foldable landing pad for drone.

### BACKGROUND OF THE INVENTION

Drones are generally landed on or taken-off from a relatively flat surfaces and away from any obstacles so that such the drones can take-off or land safely. In order to provide a designated landing/take-off space, operators normally use a landing pad that can be a permanent landing pad or a portable landing pad. Landing pads also keep dust and debris away from the drones during take-off and landing as dust and debris can cause significant damage to drone propellers and motors. However, all of the existing portable landing pads have limitations based on their design and configuration thus failing to provide an optimal performing landing pad. Due to the portable factor and being able to fit into a transporting bag, most the existing landing pad tend to smaller in size and does not provide sufficient space to take-off and land a larger sized drone. Some of the existing portable landing pads are able to overcome the smaller-sized design by introducing a foldable feature into the landing pad. However, these foldable landing pads does not provide a rigid surface area and moves because of the downdraft of the drones. Additionally, some of the existing landing pads can only be utilized during daytime and are not cleared for night operations due to lack of lighting features and tracking features.

It is an objective of the present invention to provide a foldable drone landing pad that overcomes the aforementioned limitations. A lighting system of the present invention allows the operators to carry out daytime drone operations and nighttime drone operations thus providing a detectable landing pad during any types of weather conditions. Furthermore, the present invention functions as rigid and foldable pad so that the larger sized drones can safely land without having worry about uneven terrain. Furthermore, the present invention is configured with multiple drone tracking features, such as proximity sensors, infrared beacons, wireless communication units, cameras, to enhance the safety of the drones during landing and take-off.

### BRIEF DESCRIPTION OF THE DRAWINGS

FIG. 1 is a top perspective view of the present invention in the expanded configuration.

FIG. 2 is a bottom perspective view of the present invention in the expanded configuration.

FIG. 3 is a top view of the present invention in the expanded configuration.

FIG. 4 is a left view of the present invention in the expanded configuration.

FIG. 5 is a right view of the present invention in the expanded configuration.

FIG. 6 is a top perspective view of the present invention in the folded configuration.

FIG. 7 is a bottom view of the present invention in the folded configuration.

FIG. 8 is a top view of the present invention in the folded configuration.

FIG. 9 is a top view of the present invention in the expanded configuration, wherein the dash lines illustrate internally mounted components.

FIG. 10 is a top view of the present invention in the expanded configuration.

FIG. 11 is a schematic view of the present invention, showing the electrical connections.

FIG. 12 is a schematic view of the present invention, showing the electronic connections.

### DETAIL DESCRIPTIONS OF THE INVENTION

All illustrations of the drawings are for the purpose of describing selected versions of the present invention and are not intended to limit the scope of the present invention.

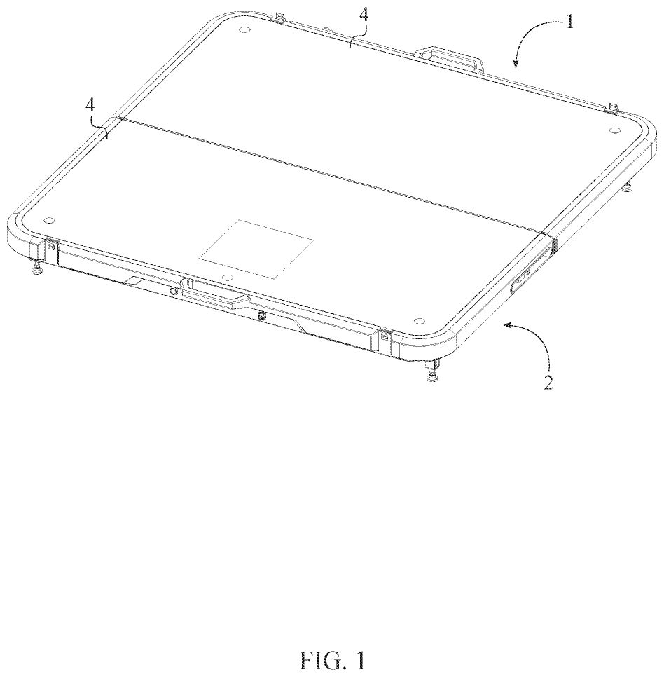

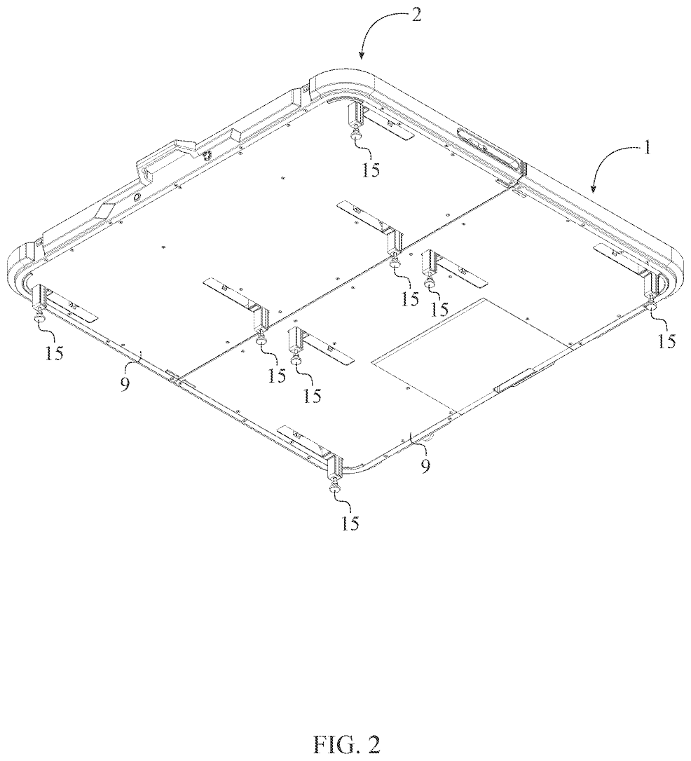

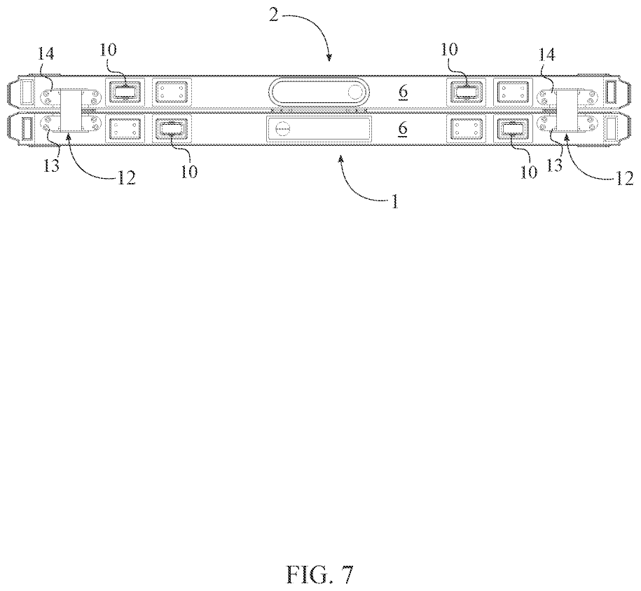

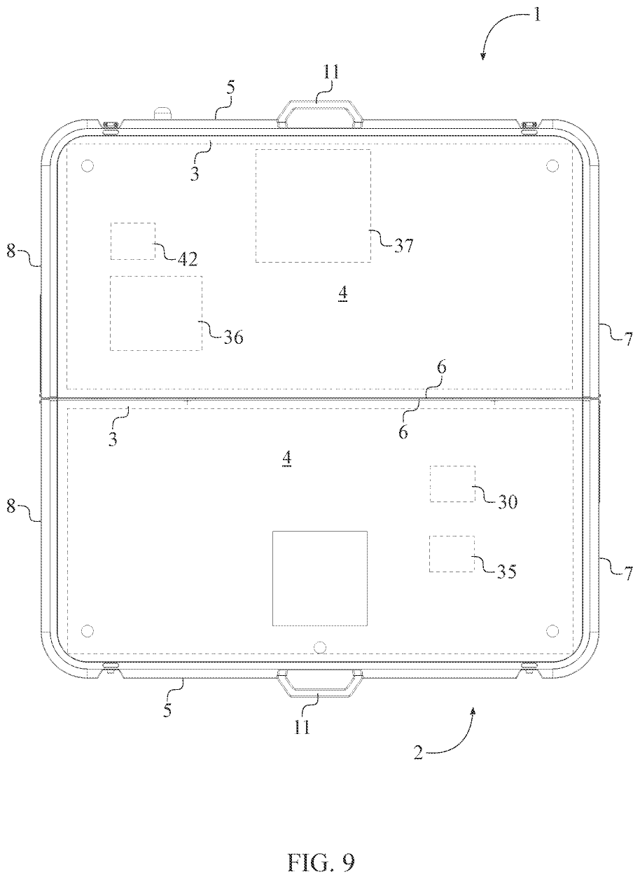

The present invention is a foldable landing pad for an unmanned aerial vehicle (UAV), commonly known as a drone. More specifically, the present invention is able to provide a portable and foldable landing pad so that the drone operators can safely and efficiently accommodate daytime drone operation and nighttime drone operation. The present invention comprises a first landing platform 1, a second landing platform 2, at least one hinge mechanism 12, a chipset 36, a rechargeable battery 37, and a plurality of drone tracking features 29 as shown in FIG. 1, FIG. 2, FIG. 7, and FIG. 9.

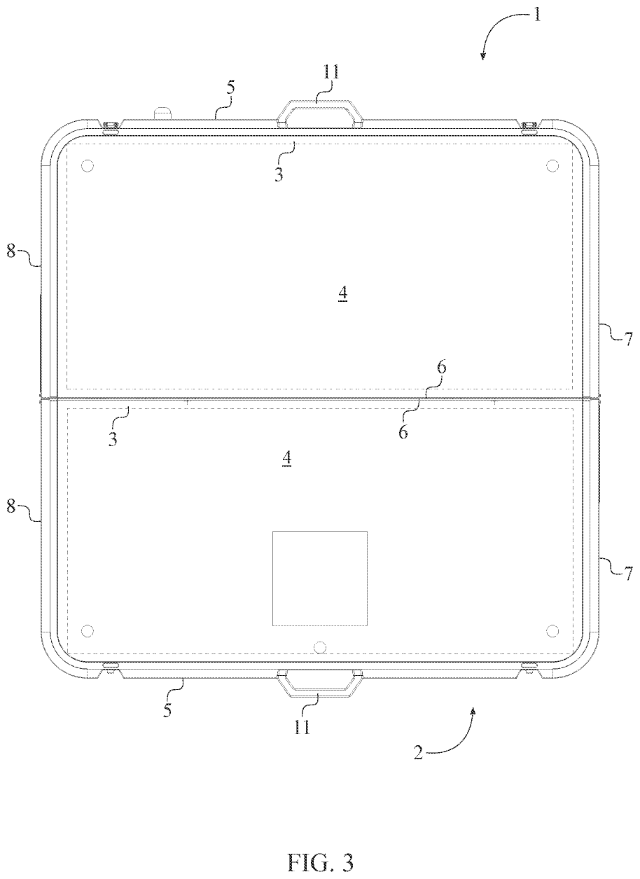

In reference to the general configuration of the present invention, as shown in FIGS. 1-6, the first landing platform 1 and the second landing platform 2 function as the landing area for the drone and foldably mounted to each other by the hinge mechanism 12. As a result, when a drone is operational, the present invention is at an expanded configuration so that the drone can land or take-off. When a drone is non-operational, the present invention is at a folded configuration thus allowing easy transportation or minimizing storage space. The first landing platform 1 and the second landing platform 2 function are formed into rectangularly-shaped bodies and each comprises a frame 3, a drone landing panel 4, an outer panel 5, an inner panel 6, a left panel 7, a right panel 8, and a bottom panel 9. More specifically, the frame 3 is enclosed being enclosed by the drone landing panel 4, the outer panel 5, the inner panel 6, the left panel 7, the right panel 8, and the bottom panel 9. The chipset 36 is a computing device that executes the data flow management of the present invention and mounted within the first landing platform 1. The rechargeable battery 37 is the power source of the present invention and internally mounted to the first landing platform 1. The plurality of drone tracking features 29 is integrated to the first landing platform 1 and the second landing platform 2 so that the present invention can perform variety of drone operational activities to safely operate the drone. The chipset 36 and the plurality of drone tracking features 29 are electrically connected to the rechargeable battery 37 to electrically power each of the plurality of drone tracking features 29 and the chipset 36. The plurality of drone tracking features 29 is electronically connected to the chipset 36 thus allowing an operator to selectively implement each of the plurality of drone tracking features 29 based on given circumstances, weather conditions, or any other drone related requirements.

In reference to FIGS. 1-3, the first landing platform 1 and the second landing platform 2 provide a pair of rigid platforms so that the present invention can be placed on any surface without any deformation. Resultantly, the drone is able to land or take-off from a rigid and flat surface area. More specifically, the drone landing panel 4 that orients toward the drone and the bottom panel 9 that orients toward the ground surface are oppositely positioned of each other about the frame 3. The outer panel 5, the inner panel 6, the left panel 7, the right panel 8 are perimetrically positioned in between the drone landing panel 4 and the bottom panel 9 and function as a lateral wall. In other words, the drone landing panel 4 is adjacently mounted to the frame 3 thus allowing a rigid surface area to land or take-off a drone. The bottom panel 9 is adjacently mounted to the frame 3 and protects any internal components of the present invention from outside elements. The outer panel 5 is laterally mounted to the frame 3. The inner panel 6 is laterally mounted to the frame 3 and positioned opposite of the outer panel 5. The left panel 7 and the right panel 8 are positioned perpendicular to the inner panel 6 and opposite of each other about the frame 3. Resultantly, the left panel 7 is laterally mounted to the frame 3. The right panel 8 is laterally mounted to the frame 3, opposite of the left panel 7. When the present invention is at the expanded configuration, the drone landing panel 4 of the first landing platform 1 is positioned coplanar to the drone landing panel 4 of the second landing platform 2 thus providing a continuous and flat surface area to land or take-off the drone. When the present invention is at the folded configuration, the drone landing panel 4 of the first landing platform 1 and the drone landing panel 4 of the second landing platform 2 are folded toward each other and positioned parallel to each other thus providing a compact body.

In reference to FIG. 7 and FIG. 9, the first landing platform 1 and the second landing platform 2 may each further comprise a pair of wheels 10 and a handle 11. The pair of wheels 10 for first landing platform 1 and the second landing platform 2 are utilized to move the folded configuration of the present invention when necessary. The handle 11 for the first landing platform 1 and the second landing platform 2 are utilized to carry and move the folded configuration and/or the expanded configuration of the present invention. More specifically, the pair of wheels 10 and the handle 11 are oppositely positioned of each other about the frame 3. The pair of wheels 10 is mounted to the frame 3 through the inner panel 6. The handle 11 is mounted to the frame 3 through the outer panel 5.

In reference to FIGS. 1-5, when the present invention is at the expanded configuration, the pair of wheels 10 of the first landing platform 1 is oriented toward the pair of wheels 10 of the second landing platform 2 so that each corresponding pair of wheels 10 can be hidden. Preferably, the pair of wheels 10 is flattened inward into a corresponding frame 3 and the inner panel 6 or inserted into an opposing cavity. For example, the pair of wheels 10 of the first landing platform 1 can be pressed into the frame 3 and the inner panel 6 of the first landing platform 1 so that the pair of wheels 10 does not restrict the movement of the second landing platform 2 into the expanded configuration. For example, the pair of wheels 10 of the first landing platform 1 can be inserted into the opposing cavity of the second landing platform 2 so that the pair of wheels 10 does not restrict the movement of the second landing platform 2 into the expanded configuration. Furthermore, the handle 11 for the first landing platform 1 and the handle 11 for the second landing platform 2 are outwardly oriented of each other about the corresponding outer panel 5.

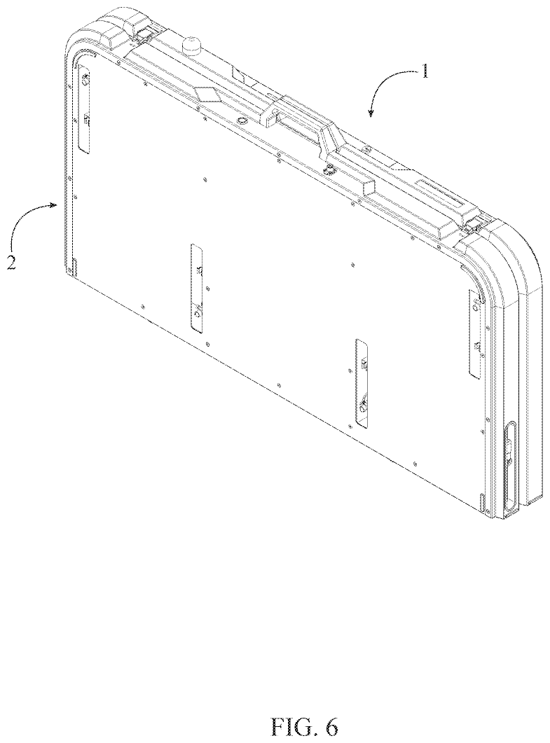

In reference to FIGS. 6-8, when the present invention is at the folded configuration, the pair of wheels 10 of the first landing platform 1 and the pair of wheels of the second landing platform 2 are oriented parallel to each other. As a result, the operator can utilize the pair of wheels 10 of the first landing platform 1 and the wheels of the second landing platform 2 to push the present invention along a ground surface. Furthermore, the handle 11 for the first landing platform 1 and the handle 11 for the second landing platform 2 are oriented parallel to each other about the corresponding outer panel 5 thus allowing the operator to grip both handle 11s from one hand.

In reference to FIG. 7, the hinge mechanism 12 may comprise a first leaf 13 and a second leaf 14 so that the first landing platform 1 and the second landing platform 2 can be hingedly mounted to each other. More specifically, the hinge mechanism 12 is positioned in between the first landing platform 1 and the second landing platform 2 thus allowing the movement between the folded configuration and the expanded configuration. The first leaf 13 is mounted to the frame 3 of the first landing platform 1 through the inner panel 6 of the first landing platform 1. The second leaf 14 is mounted to the frame 3 of the second landing platform 2 through the inner panel 6 of the second landing platform 2. As a result, the hinged mechanism 12 is able to foldably move the first landing platform 1 and the second landing platform 2. The present invention can use any industry standing hinge apparatus as the hinge mechanism 12 without deviating from the scope of the functionality.

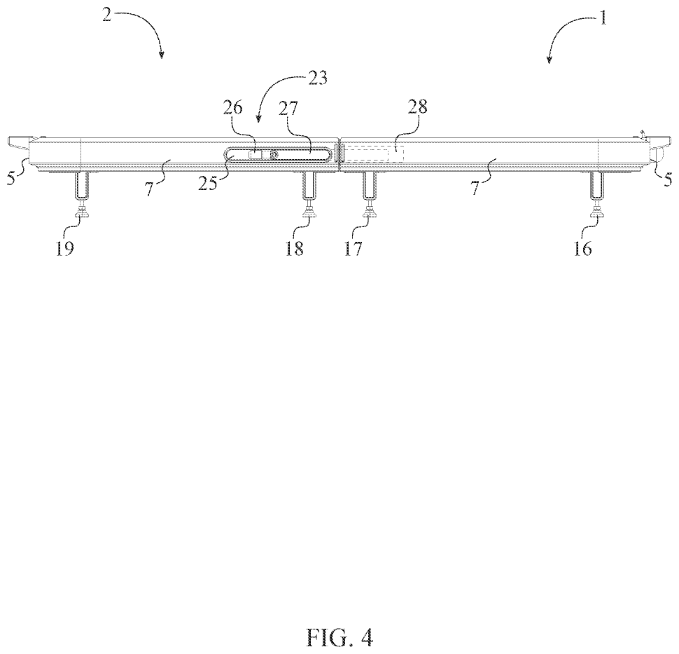

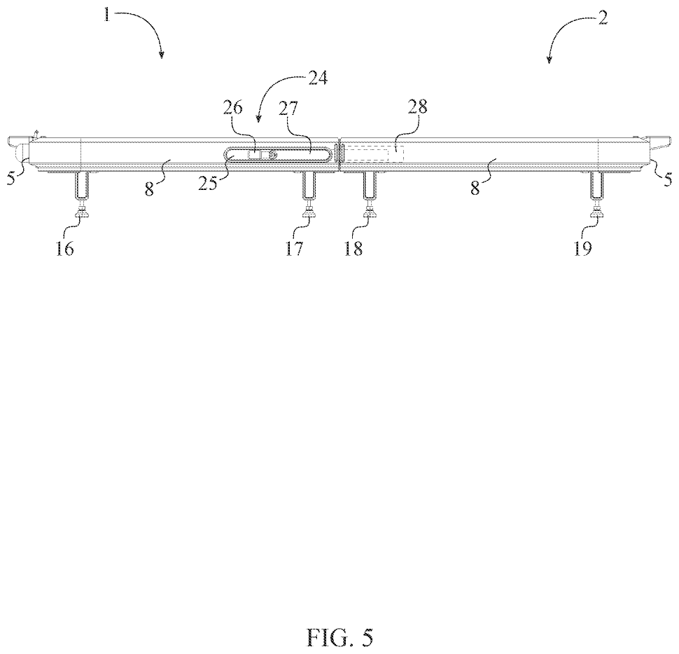

In reference to FIG. 2, FIG. 4, and FIG. 5, the present invention may further comprise a plurality of height-adjustable legs 15 so that the first landing platform 1 and the second landing platform 2 can be leveled atop uneven terrain and surface. The plurality of height-adjustable legs 15 is foldably mounted to the bottom panel 9 of the first landing platform 1 and the bottom panel 9 of the second landing platform 2 so that the operator can fold each height-adjustable leg inward during transportation and outward during drone operation. More specifically, the plurality of height-adjustable legs 15 may comprise a first pair of outer legs 16, a first pair of inner legs 17, a second pair of inner legs 18, and a second pair of outer legs 19. The first pair of outer legs 16 is positioned adjacent to the outer panel 5 of the first landing platform 1. The first pair of inner legs 17 is positioned adjacent to the inner panel 6 of the first landing platform 1. The second pair of inner legs 18 is positioned adjacent to the inner panel 6 of the second landing platform 2. The second pair of outer legs 19 is positioned adjacent to the outer panel 5 of the second landing platform 2. As a result, the first pair of outer legs 16 and the second pair of outer legs 19 are able to perimetrically support the first landing platform 1 and the second landing platform 2. The first pair of inner legs 17 and the second pair of inner legs 18 are able to centrally support the first landing platform 1 and the second landing platform 2.

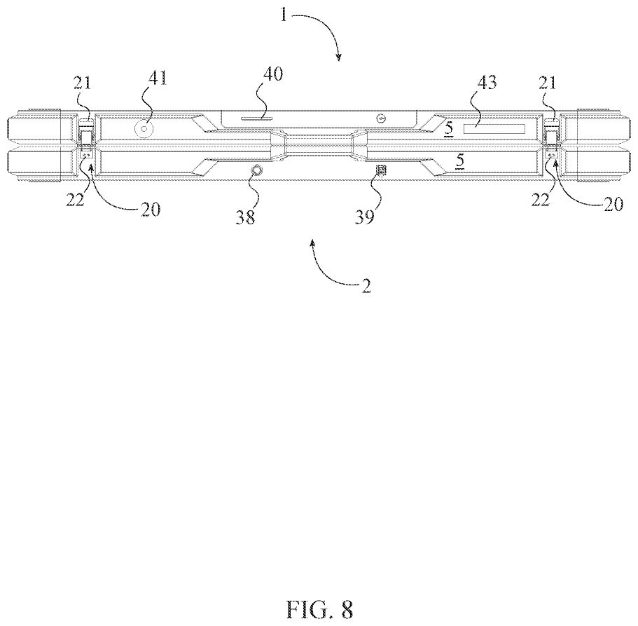

In reference to FIG. 8, the present invention may further comprise at least one locking mechanism 20 to prevent unintentional opening of the folded configuration. The locking mechanism 20 is positioned opposite of the hinged mechanism 12 and integrated to the first landing platform 1 and the second landing platform 2. More specifically, a first fastener body 21 of the locking mechanism 20 is connected to the outer panel 5 of the first landing platform 1. A second fastener body 22 of the locking mechanism 20 is connected to the outer panel 5 of the second landing platform 2. When the present invention is at the folded configuration, the operator can selectively engage the first fastener body 21 and the second fastener body 22 into each other to prevent unintentional opening. The first fastener and the second fastener need to be disengaged from each other when the present invention is changed from the folded configuration to the expanded configuration.

In reference to FIG. 4 and FIG. 5, the present invention may further comprise a first interlocking mechanism 23 and a second interlocking mechanism 24 to prevent unintentional folding of the expanded configuration. The first interlocking mechanism 23 is integrated to the left panel 7 of the first landing platform 1 and the second landing platform 2. Similarly, the second interlocking mechanism 24 is integrated to the right panel 8 of the first landing platform 1 and the second landing platform 2. More specifically, the first interlocking mechanism 23 and the second interlocking mechanism 24 may each comprise an access channel 25, a retractable handle 26, a locking plate 27, and a plate receiving cavity 28.

In reference to the first interlocking mechanism 23, as shown in FIG. 4, the access channel 25 of first interlocking mechanism 23 is traversed into the frame 3 of the second landing platform 2 through the left panel 7 so that the locking plate 27 of first interlocking mechanism 23 can slidably mount within the access channel 25 of first interlocking mechanism 23. The retractable handle 26 of first interlocking mechanism 23 is connected to the locking plate 27 of first interlocking mechanism 23 and positioned within the access channel 25 of first interlocking mechanism 23. The plate receiving cavity 28 of first interlocking mechanism 23 traverses into the frame 3 of the first landing platform 1 via the inner panel 6 thus allowing the locking plate 27 of first interlocking mechanism 23 to be slidably engaged within the plate receiving cavity 28 of first interlocking mechanism 23. In other words, the operator can pull out the retractable handle 26 away from the access channel 25 so that the locking plate 27 can be moved into the plate receiving cavity 28 to structurally maintain the expanded configuration or moved out of the plate receiving cavity 28 to initiate the folded configuration.

In reference to the second interlocking mechanism 24, as shown in FIG. 5, the access channel 25 of second interlocking mechanism 24 is traversed into the frame 3 of the first landing platform 1 through the right panel 8 so that the locking plate 27 of second interlocking mechanism 24 can slidably mount within the access channel 25 of second interlocking mechanism 24. The retractable handle 26 of second interlocking mechanism 24 is connected to the locking plate 27 of second interlocking mechanism 24 and positioned within the access channel 25 of second interlocking mechanism 24. The plate receiving cavity 28 of second interlocking mechanism 24 traverses into the frame 3 of the second landing platform 2 via the inner panel 6 thus allowing the locking plate 27 of second interlocking mechanism 24 to be slidably engaged within the plate receiving cavity 28 of second interlocking mechanism 24. In other words, the operator can pull out the retractable handle 26 away from the access channel 25 so that the locking plate 27 can be moved into the plate receiving cavity 28 to structurally maintain the expanded configuration or moved out of the plate receiving cavity 28 to initiate the folded configuration.

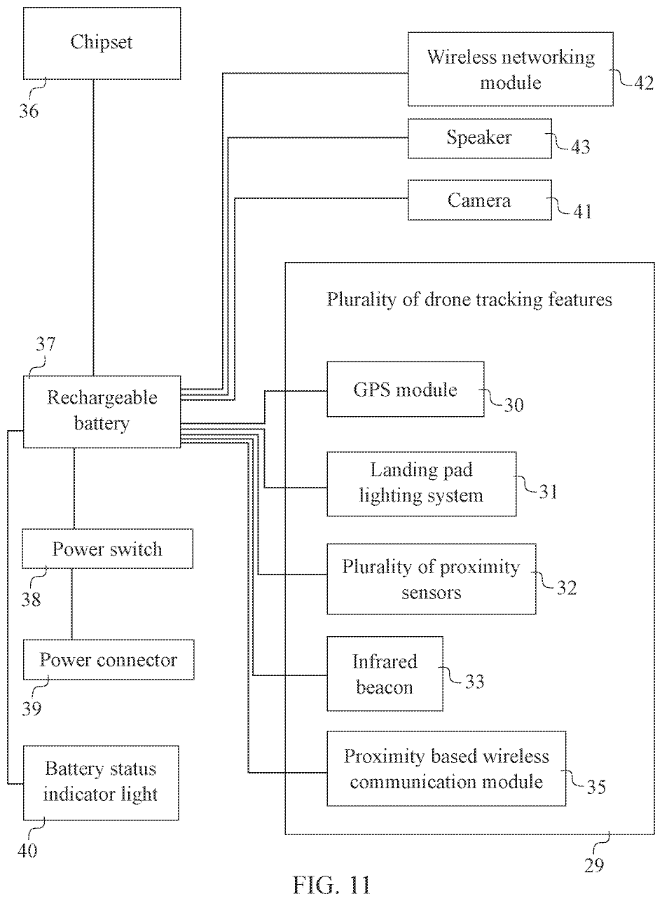

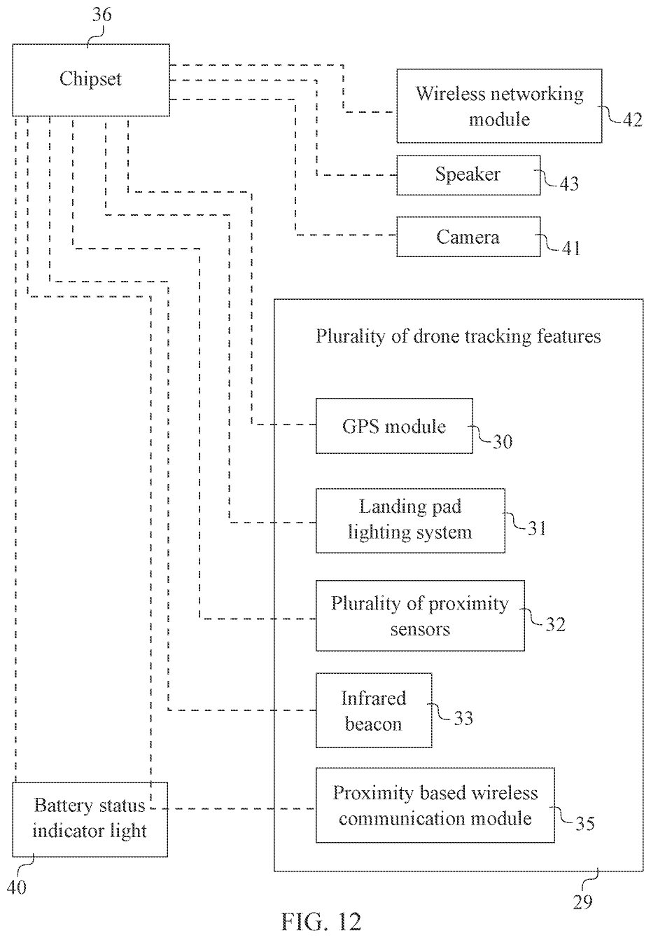

In reference to FIG. 9, FIG. 11, and FIG. 12, the plurality of drone tracking features 29 may comprise a global positioning system (GPS) module 30 so that a drone control system can communicate with the drone. Preferably, the GPS module 30 is internally mounted to the second landing platform 2; however, the GPS module 30 can also be internally mounted to the first landing platform 1 without deviating from the scope of the functionality. The GPS module 30 is electrically connected to the rechargeable battery 37 to electrically power the GPS module 30. The GPS module 30 is electronically connected to the chipset 36 thus enabling the data flow management of the present invention.

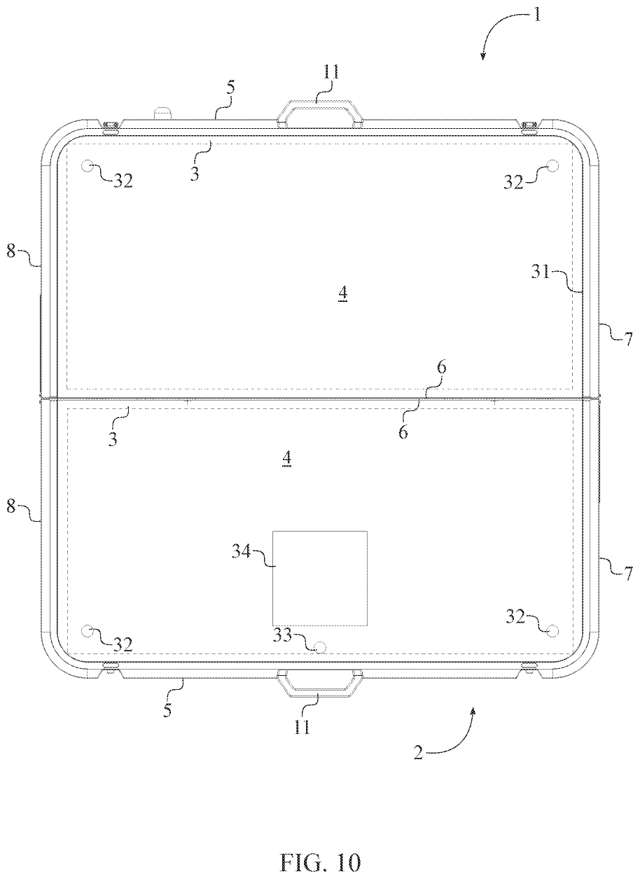

In reference to FIGS. 10-12, the plurality of drone tracking features 29 may comprise a landing pad lighting system 31 to illuminate the first landing platform 1 and the second landing platform 2 during low light conditions, night operation, and low visibility weather conditions. More specifically, the landing pad lighting system 31 is perimetrically integrated onto the drone landing panel 4 of the first landing platform 1 and the drone landing panel 4 of the second landing platform 2 so that the drone landing panel 4 can be fully and clearly visible to the operator. The landing pad lighting system 31 is electrically connected to the rechargeable battery 37 to electrically power the landing pad lighting system 31. The landing pad lighting system 31 is electronically connected to the chipset 36 thus enabling the data flow management of the present invention to turn-on and turn-off the landing pad lighting system 31 upon user preference.

In reference to FIGS. 10-12, the plurality of drone tracking features 29 may further comprise a plurality of proximity sensors 32 to guide and enhance the landing process of the drone. The plurality of proximity sensors 32 is integrated onto the drone landing panel 4 of the first landing platform 1 and the drone landing panel 4 of the second landing platform 2 so that the drone can be easily detected during operation. The plurality of proximity sensors 32 is electrically connected to the rechargeable battery 37 to electrically power the plurality of proximity sensors 32. The plurality of proximity sensors 32 being electronically connected to the chipset 36 thus enabling the data flow management of the present invention. For example, the plurality of proximity sensors 32 can be utilized to guide landing and take-off of the drone with respect to the first landing platform 1 and the second landing platform 2. For example, the plurality of proximity sensors 32 can be utilized to turn-on or turn-off the landing pad lighting system 31 with respect to the positioning of the drone.

In reference to FIGS. 10-12, the plurality of drone tracking features 29 may further comprise an infrared beacon 33 so that the drone can communicate with the present invention during nighttime to complete a precision landing. More specifically, the infrared beacon 33 is preferably integrated onto the drone landing panel 4 of the second landing platform 2. However, the infrared beacon 33 can be internally mounted to the first landing platform 1 without deviating from the scope of the functionality. The infrared beacon 33 is electrically connected to the rechargeable battery 37 to electrically power the infrared beacon 33. The infrared beacon 33 is electronically connected to the chipset 36 thus enabling the data flow management of the present invention. For example, the operator can decide when to active the infrared beacon 33 based upon the surrounding lighting of the present invention.

In reference to FIGS. 10-12, the plurality of drone tracking features 29 may further comprise a vision-based auto-landing sticker 34. Preferably, the vision-based auto-landing sticker 34 is a QR code that usually consists of many black squares in a grid. The vision-based auto-landing sticker 34 is preferably connected onto the drone landing panel 4 of the second landing platform 2 but can also be connected onto the drone landing panel 4 of the first landing platform 1. During the landing process, the drone decodes the vision-based auto-landing sticker 34 to determine the corners of the first landing platform 1 and the second landing platform 2 and to determine the distance to the drone landing panel 4. As a result, the vision-based auto-landing sticker 34 is able to function as a precision landing feature within the present invention.

In reference to FIG. 9, FIG. 11, and FIG. 12, the plurality of drone tracking features 29 may further comprise a proximity based wireless communication module 35 which is also known as a Near Field Communication (NFC) technology. The proximity based wireless communication module 35 is internally mounted to the second landing platform 2. However, the proximity based wireless communication module 35 can also be internally mounted to the first landing platform 1 without deviating from the scope of the functionality. The proximity based wireless communication module 35 is electrically connected to the rechargeable battery 37 so that the proximity based wireless communication module 35 can be electrically powered. The proximity based wireless communication module 35 is electronically connected to the chipset 36 thus enabling the data flow management of the present invention. More specifically, the proximity based wireless communication module 35 functions as a short-range communication device to wirelessly connect with other electronic components of the present invention or the drone.

In reference to FIG. 8, FIG. 11, and FIG. 12, the present invention may further comprise a power switch 38, a power connector 39, and a battery status indicator light 40 that primarily interact with the rechargeable battery 37. More specifically, the power connector 39 is connected onto the outer panel 5 of the second landing platform 2 so that the rechargeable battery 37 can be charged through an external power source. The power switch 38 is connected onto the outer panel 5 of the second landing platform 2 so that the operator can turn-on and turn-off the electrical power to all of the electrical components of the present invention. The battery status indicator light 40 is connected onto the outer panel 5 of the first landing platform 1 so that the operator can be visually informed about the battery 37 capacity. The power connector 39 is electrically connected to the rechargeable battery 37 so that electrical energy from the external power source can be transferred to the rechargeable battery 37. The power switch 38 is electrically connected between the rechargeable battery 37 and power connector 39 so that the user can control the power distribution into the electric components. The battery status indicator light 40 is electronically connected to the chipset 36 so that an accurate battery 37 capacity can be displayed to the operator.

In reference to FIG. 8, FIG. 11, and FIG. 12, the present invention may further comprise a camera 41 to the operator can remotely view the surrounding area of the first landing platform 1 and the second landing platform 2. The camera 41 is connected onto the outer panel 5 of the first landing platform 1; however, the camera 41 can also be connected to the outer panel 5 of the second landing platform 2 without deviating from the scope of the present invention. The camera 41 is electrically connected to the rechargeable battery 37 so that the camera 41 can be electrically powered. The camera 41 is electronically connected to the chipset 36 thus allowing data flow management between the camera 41 and the chipset 36.

In reference to FIG. 9, FIG. 11, and FIG. 12, the present invention may further comprise a wireless networking module 42 to facilitate wireless communication. The wireless networking module 42 is internally mounted to the first landing platform 1; however, the wireless networking module 42 can also be internally mounted to the second landing platform 2 without deviating from the scope of the present invention. The wireless networking module 42 is used for local area networking of devices and Internet access, allowing nearby digital devices to exchange data by radio waves. The wireless networking module 42 is electrically connected to the rechargeable battery 37 so that the wireless networking module 42 can be electrically powered. The wireless networking module 42 is electronically connected to the chipset 36 to enhance functionality of wirelessly operated component of the present invention (camera 41, infrared beacon 33, landing pad lighting system 31, and etc.).

In reference to FIG. 8, FIG. 11, and FIG. 12, the present invention may further comprise a speaker 43 that can convert an electrical audio signal into a specific sound. The speaker 43 is preferably connected onto the outer panel 5 of the first landing platform 1; however, the speaker 43 can also be connected onto the outer panel 5 of the second landing platform 2 without deviating from the scope of the present invention. The speaker 43 is electrically connected to the rechargeable battery 37 so that the speaker 43 can be electrically powered. The speaker 43 is electronically connected to the chipset 36 to emit the specific sound based on different activities of the present invention. For example, the speaker 43 can emit a warning sound when there is component failure within the present invention so that the operator can be informed. For example, the speaker 43 can also emit different alarms for low battery 37 capacity.

Although the invention has been explained in relation to its preferred embodiment, it is to be understood that many other possible modifications and variations can be made without departing from the spirit and scope of the invention as hereinafter claimed.

What is claimed is:

1. A foldable drone landing pad comprising:
a first landing platform;
a second landing platform;
at least one hinge mechanism;
a chipset;
a rechargeable battery;
a plurality of drone tracking features;
the first landing platform and the second landing platform each comprising a frame, a drone landing panel, an outer panel, an inner panel, a left panel, a right panel, and a bottom panel;
the frame being enclosed being enclosed by the drone landing panel, the outer panel, the inner panel, the left panel, the right panel, and the bottom panel;
the first landing platform and the second landing platform being foldably mounted to each other by the hinge mechanism;
the chipset and the rechargeable battery being internally mounted to the first landing platform;
the plurality of drone tracking features being integrated to the first landing platform and the second landing platform;
the chipset and the plurality of drone tracking features being electrically connected to the rechargeable battery; and
the plurality of drone tracking features being electronically connected to the chipset.

2. The foldable drone landing pad as claimed in claim 1 comprising:
the drone landing panel and the bottom panel being oppositely positioned of each other about the frame;
the outer panel, the inner panel, the left panel, the right panel being perimetrically positioned in between the drone landing panel and the bottom panel;
the drone landing panel being adjacently mounted to the frame;
the bottom panel being adjacently mounted to the frame;
the outer panel being laterally mounted to the frame;
the inner panel being laterally mounted to the frame, opposite of the outer panel;
the left panel and the right panel being positioned perpendicular to the inner panel;
the left panel being laterally mounted to the frame; and
the right panel being laterally mounted to the frame, opposite of the left panel.

3. The foldable drone landing pad as claimed in claim 1 comprising:
the first landing platform and the second landing platform each further comprising a pair of wheels and a handle;
the pair of wheels and the handle being oppositely positioned of each other about the frame;
the pair of wheels being mounted to the frame through the inner panel; and
the handle being mounted to the frame through the outer panel.

4. The foldable drone landing pad as claimed in claim 1 comprising:
the hinge mechanism comprising a first leaf and a second leaf;
the hinge mechanism being positioned in between the first landing platform and the second landing platform;
the first leaf being mounted to the frame of the first landing platform through the inner panel of the first landing platform; and
the second leaf being mounted to the frame of the second landing platform through the inner panel of the second landing platform.

5. The foldable drone landing pad as claimed in claim 1 comprising:
a plurality of height-adjustable legs; and
the plurality of height-adjustable legs being foldably mounted to the bottom panel of the first landing platform and the bottom panel of the second landing platform.

6. The foldable drone landing pad as claimed in claim 5 comprising:
the plurality of height-adjustable legs comprising a first pair of outer legs, a first pair of inner legs, a second pair of inner legs, and a second pair of outer legs;
the first pair of outer legs being positioned adjacent to the outer panel of the first landing platform;
the first pair of inner legs being positioned adjacent to the inner panel of the first landing platform;
the second pair of inner legs being positioned adjacent to the inner panel of the second landing platform; and
the second pair of outer legs being positioned adjacent to the outer panel of the second landing platform.

7. The foldable drone landing pad as claimed in claim 1 comprising:
at least one locking mechanism;
the locking mechanism being positioned opposite of the hinged mechanism;
the locking mechanism being integrated to the first landing platform and the second landing platform;
a first fastener body of the locking mechanism being connected to the outer panel of the first landing platform;
a second fastener body of the locking mechanism being connected to the outer panel of the second landing platform; and
the first fastener body and the second fastener body being selectively engaged with each other.

8. The foldable drone landing pad as claimed in claim 1 comprising:
a first interlocking mechanism;
a second interlocking mechanism;
the first interlocking mechanism being integrated to the left panel of the first landing platform and the second landing platform; and
the second interlocking mechanism being integrated to the right panel of the first landing platform and the second landing platform.

9. The foldable drone landing pad as claimed in claim 8 comprising:
the first interlocking mechanism comprising an access channel, a retractable handle, a locking plate, and a plate receiving cavity;
the access channel of first interlocking mechanism traversing into the frame of the second landing platform through the left panel;
the locking plate of first interlocking mechanism being slidably mounted to the access channel of first interlocking mechanism;
the retractable handle of first interlocking mechanism being connected to the locking plate of first interlocking mechanism;
the retractable handle of first interlocking mechanism being positioned within the access channel of first interlocking mechanism;
the plate receiving cavity of first interlocking mechanism traversing into the frame of the first landing platform; and
the locking plate of first interlocking mechanism being slidably engaged within the plate receiving cavity of first interlocking mechanism.

10. The foldable drone landing pad as claimed in claim 8 comprising:
the second interlocking mechanism comprising an access channel, a retractable handle, a locking plate, and a plate receiving cavity;
the access channel of second interlocking mechanism traversing into the frame of the first landing platform through the right panel;
the locking plate of second interlocking mechanism being slidably mounted to the access channel of second interlocking mechanism;
the retractable handle of second interlocking mechanism being connected to the locking plate of second interlocking mechanism;
the retractable handle of second interlocking mechanism being positioned within the access channel of second interlocking mechanism;
the plate receiving cavity of second interlocking mechanism traversing into the frame of the second landing platform; and
the locking plate of second interlocking mechanism being slidably engaged within the plate receiving cavity of second interlocking mechanism.

11. The foldable drone landing pad as claimed in claim 1 comprising:
the plurality of drone tracking features comprising a global positioning system (GPS) module;
the GPS module being internally mounted to the second landing platform;
the GPS module being electrically connected to the rechargeable battery; and
the GPS module being electronically connected to the chipset.

12. The foldable drone landing pad as claimed in claim 1 comprising:
the plurality of drone tracking features further comprising a landing pad lighting system;
the landing pad lighting system being perimetrically integrated onto the drone landing panel of the first landing platform and the drone landing panel of the second landing platform;
the landing pad lighting system being electrically connected to the rechargeable battery; and
the landing pad lighting system being electronically connected to the chipset.

13. The foldable drone landing pad as claimed in claim 1 comprising:
the plurality of drone tracking features further comprising a plurality of proximity sensors;
the plurality of proximity sensors being integrated onto the drone landing panel of the first landing platform and the drone landing panel of the second landing platform;
the plurality of proximity sensors being electrically connected to the rechargeable battery; and
the plurality of proximity sensors being electronically connected to the chipset.

14. The foldable drone landing pad as claimed in claim 1 comprising:
the plurality of drone tracking features further comprising an infrared beacon;
the infrared beacon being integrated onto the drone landing panel of the second landing platform;
the infrared beacon being electrically connected to the rechargeable battery; and
the infrared beacon being electronically connected to the chipset.

15. The foldable drone landing pad as claimed in claim 1 comprising:
the plurality of drone tracking features further comprising a vision-based auto-landing sticker; and
the vision-based auto-landing sticker being connected onto the drone landing panel of the second landing platform.

16. The foldable drone landing pad as claimed in claim 1 comprising:
the plurality of drone tracking features further comprising a proximity based wireless communication module;
the proximity based wireless communication module being internally mounted to the second landing platform;
the proximity based wireless communication module being electrically connected to the rechargeable battery; and
the proximity based wireless communication module being electronically connected to the chipset.

17. The foldable drone landing pad as claimed in claim 1 comprising:
a power switch;
a power connector;
a battery status indicator light;
the power connector being connected onto the outer panel of the second landing platform;
the power switch being connected onto the outer panel of the second landing platform;
the battery status indicator light being connected onto the outer panel of the first landing platform;
the power connector being electrically connected to the rechargeable battery;
the power switch being electrically connected between the rechargeable battery and the power connector; and
the battery status indicator light being electronically connected to the chipset.

18. The foldable drone landing pad as claimed in claim 1 comprising:
a camera;
the camera being connected onto the outer panel of the first landing platform;
the camera being electrically connected to the rechargeable battery; and
the camera being electronically connected to the chipset.

19. The foldable drone landing pad as claimed in claim 1 comprising:
a wireless networking module;
the wireless networking module being internally mounted to the first landing platform;
the wireless networking module being electrically connected to the rechargeable battery; and
the wireless networking module being electronically connected to the chipset.

20. The foldable drone landing pad as claimed in claim 1 comprising:
a speaker;
the speaker being connected onto the outer panel of the first landing platform;
the speaker being electrically connected to the rechargeable battery; and
the speaker being electronically connected to the chipset.
